(19) United States
(12) Patent Application Publication
(10) Pub. No.: US 2007/0274090 A1
(43) Pub. Date: Nov. 29, 2007

(54) Vehicle Headlight and Lamp

(75) Inventor: Helmut Tiesler-Wittig, Langerwehe (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,816

(22) PCT Filed: Dec. 20, 2004
(86) PCT No.: PCT/IB04/52861

§ 371 Date: Jun. 12, 2007

(30) Foreign Application Priority Data
Jan. 7, 2004 (EP) 04100019.1

(51) Int. Cl. B60Q 1/00

(52) U.S. Cl. 362/548; 362/519; 362/549; 362/647

(57) ABSTRACT

A vehicle headlight is described with a reflector housing (1, 21) and a front glass (22) which together enclose a headlight inner space. The headlight has a reference surface (15, 35) for defining the position of a lamp (7, 30) having a lamp body (8, 31) and a lamp base (9, 37) in the headlight The headlight is constructed such that the lamp (7, 30) can be inserted such that the lamp base (9, 37) is positioned in front of the lamp body (8, 31), viewed against the direction of radiation of the headlight In addition, a lamp (7, 30) is described which is constructed such that it can be inserted into the vehicle headlight in the manner described.

The invention relates to a vehicle headlight, in particular for motor vehicles, and to a lamp for such a vehicle headlight.

The development of high-output vehicle headlights leads to technical systems of ever increasing complexity with the object of achieving as good as possible an illumination of the traffic space on the one hand, so as to provide the driver of a vehicle with a good view, and on the other hand of avoiding dazzling of the oncoming traffic so as not to bring the oncoming traffic into danger.

To exclude a dazzling of the oncoming traffic with certainty, therefore, a so-called bright-dark boundary or cut-off is stipulated for the low-beam function in relevant standards, which prescribe an asymmetrical shape for the illuminated traffic space. It should be heeded in the construction of lamps and headlights and in the installation and arrangement of the headlight in the vehicle that only the traffic space below this bright-dark cut-off is illuminated. The bright-dark cut-off is achieved in many cases by a suitable shading of the dark region by means of suitably positioned and shaped screen caps or diaphragms in the lamp itself or in the headlight. Examples of this are radiation screens which prevent a direct front view of the light source. They are either integrated into the system of the lamp, for example in that they are provided on the lamp body, or they are arranged, for example, in the form of metal screen caps on supports in the reflector of the headlight. The interaction between the construction of the lamp and that of the headlight, the latter in particular by means of the shape of the reflector, special scattering disks in the reflector, or optical elements in the reflector glass, also renders it possible to redistribute the light such that no light is radiated into the dark region above the bright-dark cut-off. It is in particular the position of the lamp inside the headlight that plays a decisive role for the radiation characteristic of a headlight system consisting of a headlight and a lamp mounted therein. This characteristic is defined by a reference surface in the headlight against which the lamp is made to abut during its mounting.

To achieve as good as possible an illumination of the traffic space, gas discharge lamps have been used for a few years in motor vehicle lamp industry. Such gas discharge lamps have a discharge vessel filled with an inert gas and are made from a translucent, heat-resistant material, for example quartz glass. Electrodes project into this discharge vessel, and a voltage is applied to said electrodes for igniting and operating the lamp. Typical gas discharge lamps used nowadays in motor vehicles are, for example, so-called HID (High Intensity Discharge) lamps such as, for example MPXL (Micro Power Xenon Light) lamps, which operate with a xenon gas filling. A problem of the use of such gas discharge lamps, however, is that the discharge lamp emits not only the desired light, but also a high proportion of electromagnetic interference radiation owing to the physical properties of the respective inert gas, for example the xenon gas, and the discharge phenomenons resulting therefrom. The interference radiation may lead to electromagnetic interference with other electronic units such as, for example, an audio set or an ABS, and thus to malfunctions of the relevant devices, which is why there are both legal EMC (ElectroMagnetic Compatibility) requirements and comparatively strict EMC requirements imposed by the automobile industry itself. These lead to a further increase in the complexity of the headlight and/or the lamp owing to the necessity of a screening.

An exchange of lamps is mostly carried out by service personnel of the vehicle manufacturer because an intervention in this complicated headlight system, for example in exchanging a lamp, may impair the optical quality owing to pollution through inexpert handling or bad mounting. This personnel is capable of exchanging the lamps from the rear of the headlight. The available constructional space, however, is often very limited in the engine compartments of modern vehicles. The mounting and dismounting of the lamps is accordingly quite complicated and time-consuming. Other components of the vehicle even have to be temporarily removed in some vehicle types for an exchange of lamps. This is not only inconvenient, but also time-consuming and expensive.

It is an object of the present invention to provide an alternative to the prior art mentioned above, rendering possible an inexpensive, space-saving construction of the lamp and the headlight in combination with a simple mounting of the lamp and maintenance of the headlight.

This object is achieved by means of a vehicle headlight, in particular for motor vehicles, with a reflector housing and a front glass which together enclose a headlight inner space, and with a reference surface for defining the position of a lamp having a lamp body and a lamp base inside the headlight, wherein the headlight is constructed such that a lamp can be inserted such that the lamp base is positioned in front of the lamp body, when viewed against the radiation direction of the headlight.

The lamp base of the vehicle headlight according to the invention now lies in the headlight inner space, in contrast to known headlights in which the reference surface with the holder for the lamp is arranged in the reflector region and accordingly the holder will usually project from the rear of the headlight housing. The invention thus distances itself from the traditional principle of arranging a lampholder in a rear wall of the headlight, which will usually serve as the reflector. Instead, the invention moves the lampholder and thus also the reference surface into the headlight inner space between the front glass and the reflector. The free space present there anyway and technically necessary is thus utilized. The headlight can now be constructed with a smaller depth in the absence of a lampholder projecting beyond the reflector rear, so that space required for this purpose is made free in the engine compartment.

A further advantage of this arrangement is that the absence of the lampholder in the reflector region leads to a gain in reflector surface area. The surface area that had been occupied until now by the lampholder will now be available for the reflection of radiation emitted by the lamp against the radiation direction of the headlight, which leads to a better luminous efficiency of the headlight.

Conventional reference surfaces are usually mechanically fixedly connected to the reflectors. Since the reflectors have to support the weight of the lamp body and of the lamp base also under impacts, they are of a suitably stable construction. The invention here renders it possible to simplify the construction of the reflectors: since the front glass is exposed to major loads and is accordingly of a stable construction anyway, the reference surface in the headlight according to the invention may also be arranged on the front glass of the headlight without necessitating a reinforcement of the front glass construction. The construction of the reflector housing, by contrast, may then be substantially simpler and lighter.

The lampholder basically serves as a connection between the lamp and the headlight housing. At the headlight side, it represents the mechanical and electrical interface via which a retention of the lamp is safeguarded and its position in the headlight inner space is defined, and via which at the same time the lamp receives its electrical supply. Preferably, the latter takes place without problems by means of electrical supply lines which are passed into the interior of the headlight. If the lamp is provided with an electronic circuit for controlling its operation, in particular its starting phase by acting as a Starter, the latter is advantageously arranged inside the lamp base.

Furthermore, if the lamp is a gas discharge lamp emitting the interference radiation mentioned above, a screening device against this radiation is necessary, for example in that the reflector or additional screening parts inside the lamp are grounded. In a preferred embodiment, the supply lines for supplying the electronic circuit are accordingly passed alongside the lamp body of an inserted lamp such that they screen said body against electromagnetic interference radiation issuing therefrom. Additional measures such as shields or separate ground connections are made redundant thereby, because this function is taken over by the supply lines that are present anyway and that for this purpose are preferably passed alongside the lamp in longitudinal direction thereof. It is not excluded, however, that additional screening measures are taken in special applications.

A particularly advantageous embodiment of the invention provides that at least three supply lines extend parallel to a longitudinal axis of the lamp body and are arranged around the lamp body in a stellar arrangement with respect to the longitudinal axis at substantially equal angular distances to one another. This means in the case of three supply lines that the latter have mutual angular distances of 120°, that the angular distance between two mutually adjoining supply lines is 90° each time in the case of four supply lines, etc. Such an arrangement leads to a symmetrical configuration which is particularly suitable for screening off interferences with other electronic components.

The supply lines may be integrated, as has been usual until now, in a lampholder of the headlight of more complicated construction, where they are contacted with the lamp base upon insertion thereof. In an advantageous embodiment of the invention, the supply lines are mechanically fixedly connected to the reflector housing and are of a rigid construction, for example in the form of comparatively thick bridges, so that they themselves form a support for the lamp in the reflector housing with a reference surface. At least the live supply lines are electrically insulated from the reflector in this case and are connected to the electrical network of the vehicle. Alternatively, the reference surface may be fixedly connected to the front glass by means of the supply lines. Contacting between the supply lines and the vehicle network should then be achieved via suitable conductors in or on the front glass. The supply lines should preferably be insulated against human contact in either case, for example by means of an insulating lacquer or the like. A ground contact, which would be present in the case of additionally provided screens for screening off electromagnetic interference radiation, however, is not absolutely necessary here. An individual, more complicated component for the lampholder in the headlight is thus redundant in all cases, so that the manufacturing cost of the headlight can be reduced.

Various possibilities are conceivable according to which the supply lines can constitute a support or holder for the lamp base. In a particularly advantageous embodiment of the invention, the rigid supply lines are connected at their front ends to contacts for contacting the electronic lamp circuit, which contacts are arranged in a ring. This ring connects the stable supply lines mechanically with one another, but is electrically insulated from the supply lines and contacts. The ring here represents the reference surface for the lamp in the headlight inner space. This configuration is the simplest embodiment of a support or holder formed by the supply lines, by means of which a reference surface is formed for defining the position of the lamp in the headlight.

The lampholder of the headlight is to retain the lamp base so fixedly that it cannot detach itself from the lampholder under the influence of the sometimes considerable impacts that occur in a motor vehicle, while an electrical contact between the lampholder and the lamp base is not broken. To achieve this, the lamp may be screwed or clamped into the lampholder, whereupon the contacts are closed, for example by means of plug connectors. In an advantageous embodiment of the invention, a mechanical locking of the lamp in the reflector housing is provided, wherein particularly preferably at the same time contacts between the supply lines and the electronic circuit are closed as part of the locking process. This renders a separate process step for creating an electrical contact during insertion of the lamp redundant, while advantageously the contacts of the supply lines at the same time form locking means in the lampholder. A high operational reliability and protection from incorrect use are achieved thereby.

The object is furthermore achieved by means of a vehicle headlight, in particular for motor vehicles, with a reference surface in a reflector housing for defining the position of a lamp in the headlight, wherein the lamp comprises a lamp body holder and a lamp socket, and the lamp and the headlight are designed such that the lamp can be inserted such that the lamp body holder is arranged in front of the lamp body, when viewed against the radiation direction of the headlight, and the lamp socket is arranged behind it so as to abut against the reference surface.

This vehicle headlight according to the invention thus has a conventional arrangement of the reference surface in the reflector housing. The inventive idea here relates to the lamp base. The base of a conventional lamp performs two functions: on the one hand, it keeps the lamp body in the lamp, i.e. connecting it, for example, to the electronic circuit. On the other hand, it retains the lamp in the headlight, thus forming the interface between the lamp and the headlight at the reference surface. The lamp according to the invention, by contrast, separates these two functions of the lamp base and assigns them to two separate components, i.e. to a lamp body holder and to a lamp socket. These components are at mutually opposed ends of the lamp body. It is achieved thereby that the space in the inner compartment of the headlight, which is technically necessary anyway, is usefully employed for components of the lamp, i.e. the retention means for the lamp body.

Advantageously, therefore, the lamp body holder is arranged in the region of the radiation screen, whereby the space requirement in the region of the lamp socket is reduced. The projection of the lamp inserted in the headlight beyond the reflector housing into the engine compartment can be clearly reduced in this manner. This advantage can be enhanced when also the electronic circuit of the lamp is integrated in the lamp socket and both are arranged in the region of the radiation screen, or themselves serve as such. Furthermore, this embodiment has the advantage that reflectors already existing in a few vehicle types can be used in the invention, i.e. reflectors in which suitable reference surfaces for the incorporation of conventional lamps were integrated comparatively inexpensively during manufacture. This construction obviously also renders possible the arrangement of electrical supply lines to the lamp or electronic circuit in a manner that screens radiation, as was described above.

The object is furthermore achieved by means of a vehicle headlight which is constructed in particular in accordance with one of the above embodiments and which is constructed such that a lamp with its electronic circuits can be inserted into the reflector housing from the front, after removal of the front glass. Such a headlight according to the invention, unlike conventional headlights, now follows the principle that the headlight inner space is no longer opened from the side of the headlight facing the engine compartment, i.e. passing through the reflector, but from the front. This leads first of all to a substantially simplified maintenance of the headlight, because it is no longer necessary to enter the engine compartment for mounting the lamp, for which possibly in particular vehicle components arranged behind the headlight are to be removed, on the one hand, while on the other hand more working space is available to the operator for removing and inserting the lamp in front of and inside the headlight inner space. In addition, the constructional space behind the headlight in the engine compartment may now be fully utilized for other components. Advantageously, the front glass is connected to the reflector via a hinge, so that the front glass can be pivoted from an operational position into a maintenance position for mounting and maintaining the lamp, and can be moved back into its operational position in a reliable manner after completion of the maintenance.

The object is furthermore achieved by means of a vehicle lamp, which can be used in particular in motor vehicles and which comprises a lamp body, a lamp base, a radiation screen, and an electronic circuit preferably serving as a starter for operating the lamp, wherein the electronic circuit is arranged in the region of the radiation screen. The principle of the invention accordingly is to connect the electronic circuit, electrically arranged between the contacts of the lamp base and the lamp body, and the radiation screen spatially. Advantageously, a component comprising the electronic circuit of the lamp is arranged to serve as the radiation screen. Freed from the electronic circuit, the lamp base can now be given smaller dimensions and a simpler construction, and the region of the lamp required anyway for a radiation screen is utilized for accommodating the electronic circuit.

In a modified embodiment, the lamp base, and accordingly the contacts of the lamp base, are spatially separated from one another for connection to the vehicle's electrical circuit on the one hand and to the electronic lamp circuit to be connected on the other hand, i.e. at the mutually opposed ends of the elongate lamp body. Supply lines are required in this case which provide an electrical connection between the lamp base and the electronic circuit. In a preferred embodiment of the invention, these electrical supply lines are provided at or in the lamp body, i.e. not in the holder for the lamp, in contrast to an embodiment of a headlight described above. Preferably, however, the supply lines are arranged such that they screen the lamp body of a gas discharge lamp against electromagnetic interference radiation issuing therefrom. For this purpose, the supply lines preferably run in longitudinal direction of the elongate lamp body and thus render otherwise necessary additional measures for electromagnetic screening of the gas discharge lamp redundant. Three supply lines are advantageously provided for this purpose, extending parallel to a longitudinal axis of the lamp body and arranged around the lamp body in a stellar shape with respect to the longitudinal axis at angles of 120° to one another. As in the lampholder in the headlight mentioned above, this arrangement of the supply lines with respect to the lamp constitutes a suitable configuration for a reliable electromagnetic screening.

The lamp described above is based on an arrangement of the lamp base in a usual manner, i.e. in a position opposite to the radiation screen of the lamp. The result is that this modified embodiment is also suitable for retrofit purposes in existing headlight types, given a suitable construction of the lamp base. The lamp base need merely fit the lampholder present in the headlight, but may otherwise be of a considerably smaller construction, because no space is required in the lamp base for the electronic circuit in this modification.

In another preferred embodiment of the invention, the lamp base is also arranged in the region of the radiation screen, or itself serves as such. This embodiment accordingly unites the electronic circuit and the lamp base and further utilizes the advantages obtained through the positioning of the electronic circuit in the region of the radiation screen. Such a lamp can be used especially in a headlight as described in detail above, whose lampholder and reference surface lie in the headlight interior, so that all concomitant advantages can be utilized. The task of screening the lamp body against electromagnetic interference radiation also taken over by the supply lines in the embodiment of the lamp described above is performed in this embodiment by supply lines in the headlight which at the same time are capable of providing the retention against a reference surface for the position of the lamp in the headlight.

Since the lamp base faces towards the inner side of the front glass, a support is also conceivable, as was noted above, which is arranged against the front glass of the headlight, which front glass is after all stable. This means that the reflector need no longer carry the weight of the lamp, and can thus be manufactured so as to be less bulky and less expensive.

The lamps described above have a lamp base which performs two functions: supporting the lamp body in the lamp on the one hand and supporting the lampholder in the headlight on the other hand. In an alternative embodiment of the invention, the lamp base is divided into a lamp body holder and a lamp socket, such that only the lamp body holder is positioned in the region of the radiation screen. The functions of the lamp base, i.e. supporting the lamp body and retaining the lamp in the headlight, are separated and assigned to different components. These components, i.e. the retention means for the lamp body in the lamp and the retention means for the lamp in the headlight, are at different, mutually opposed ends of the lamp body. It is achieved thereby that the lamp is still fixedly positioned against a reference surface immediately at the reflector housing. The lampholder of the lamp, however, no longer projects substantially beyond the rear of the reflector housing into the engine compartment, because it is freed from further functions, i.e. of retaining the lamp body and of accommodating the electronic circuit.

A headlight system formed with a vehicle headlight according to the invention and a vehicle lamp according to the invention may be marketed as a complete system, for example along with a new vehicle or as a retrofit unit for existing vehicles. In such a headlight system, all advantages of the economical manufacture and space-saving construction of the headlight and the vehicle lamp are combined with the advantages of the more convenient handling of the headlight during mounting and maintenance. In addition, the vehicle headlight and the vehicle lamps may also be separately marketed, for example as spare parts.

The object is furthermore achieved by the use of an electronic component and/or a lamp base of a vehicle lamp which is designed for use in a vehicle headlight as a radiation screen arranged in front of the lamp, as viewed against the radiation direction of the headlight. The electronic component is then a component which comprises a substantial portion of the electronics, preferably the entire electronics, necessary for operating the lamp. Its use as a radiation screen renders the mounting of a separate component serving as a radiation screen unnecessary, so that the space in the lamp required anyway for a radiation screen is advantageously doubly utilized. The radiation screen serves to cut off stray light wandering through the optical system and to prevent a direct view of the light source.

The above object is finally achieved by means of a method of exchanging a motor vehicle lamp arranged inside a headlight housing in a holder, wherein the headlight housing comprises a front glass arranged at the front, which together with a reflector positioned behind it encloses a space, in which method the front glass is removed, a lamp with its electronics arranged in said space is removed from its support, a new, similar lamp is inserted into the support, and the space is closed again by means of the front glass. Since the headlight need no longer be serviced from the engine compartment side in this method, vehicle components may be arranged in the immediate vicinity of the headlight in the engine compartment, which components need not be dismantled for the exchange of lamps. The space in the engine compartment is thus better utilized, while the lamp exchange process is nevertheless considerably simplified. This means that also the vehicle owner can exchange defective lamps himself without problems again and is no longer dependent on service personnel, which substantially contributes in particular to the safety of the vehicle and its occupants in traffic at night.

The invention will be explained in more detail below for greater clarity with reference to the appended drawings and advantageous embodiments. In the drawings:

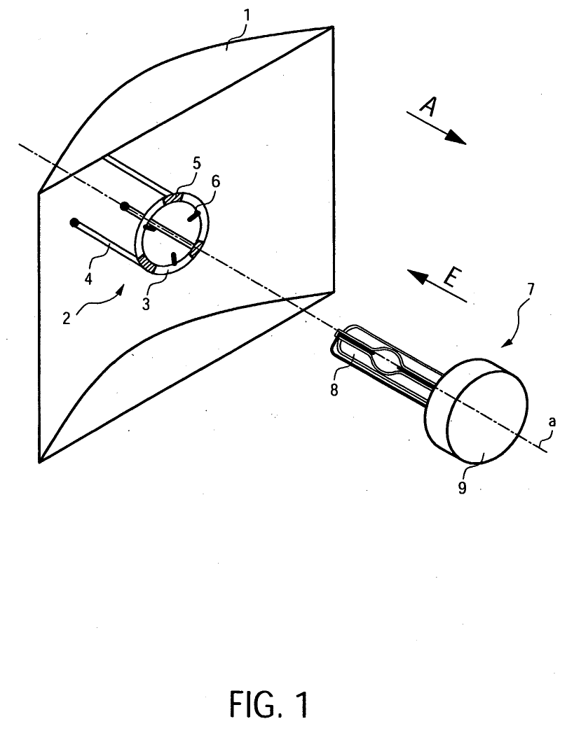

FIG. 1 is a diagrammatic view of a reflector housing with a holder and a gas discharge lamp,

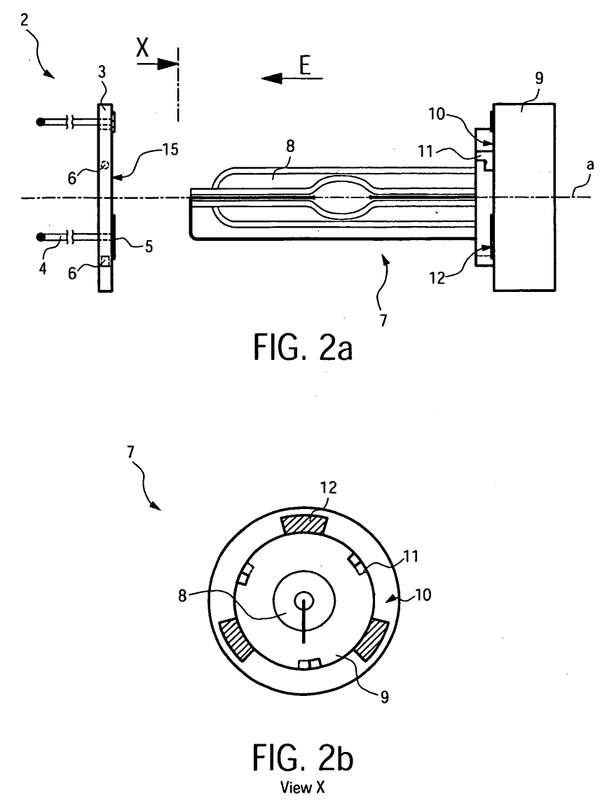

FIG. 2a diagrammatically shows a first embodiment of the gas discharge lamp and the support of FIG. 1 in side elevation,

FIG. 2b is a plan view of the gas discharge lamp of FIG. 2a,

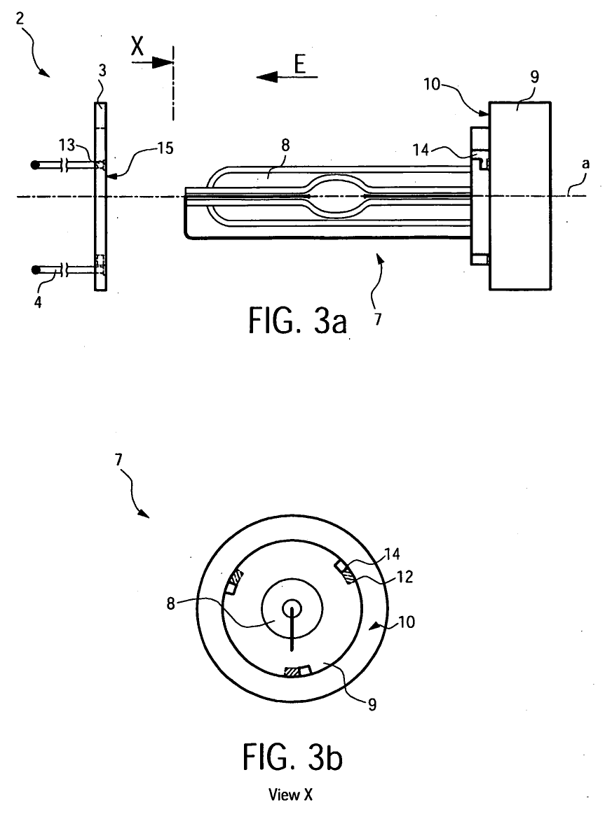

FIG. 3a diagrammatically shows a second embodiment of the gas discharge lamp and the support of FIG. 1 in side elevation,

FIG. 3b is a plan view of the gas discharge lamp of FIG. 3a,

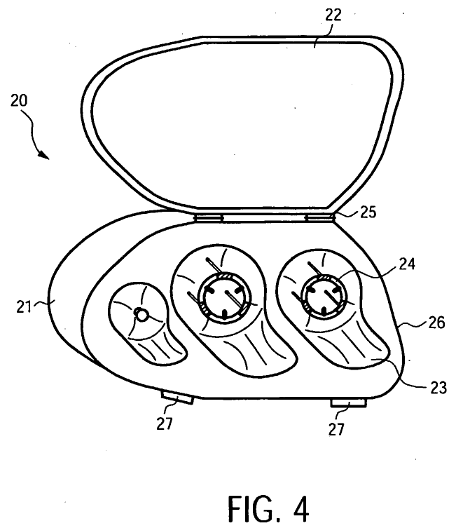

FIG. 4 is a diagrammatic view of a headlight with the front glass hinged open,

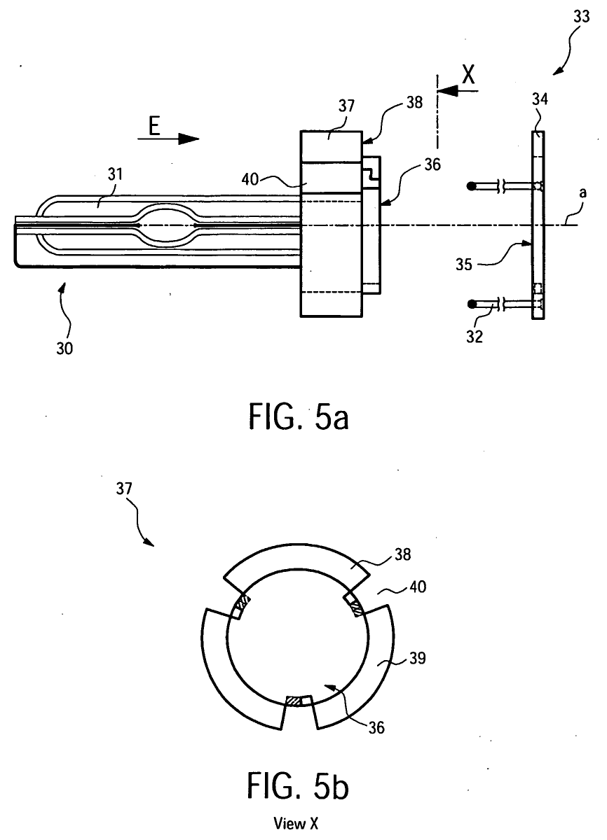

FIG. 5a diagrammatically shows a third embodiment of a gas discharge lamp and a holder in side elevation,

FIG. 5b is a plan view of the gas discharge lamp of FIG. 5a,

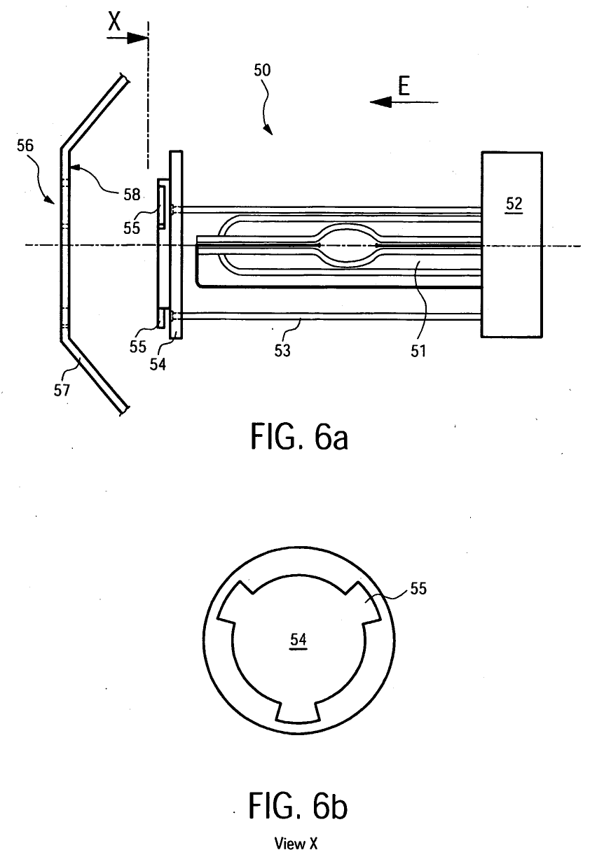

FIG. 6a diagrammatically shows a fourth embodiment of a gas discharge lamp and a holder in side elevation, and

FIG. 6b is a front view of the holder of the gas discharge lamp of FIG. 6a.

FIG. 1 is a diagrammatic view of a reflector housing 1 of a headlight for a vehicle. It comprises a holder 2 with a ring 3 which forms a reference surface for the position of a vehicle lamp in the reflector housing 1 and which is supported by bridges 4. The bridges 4 make contact with the ring 3 at points along one third of its circumference each time, such that the bridges 4 define an equilateral triangle, viewed in a direction parallel to their longitudinal extensions, and are arranged around the center of the ring 3 at angles of 120° to one another.

At its side facing away from the reflector housing 1, the ring 3 furthermore has contact surfaces 5 and, at its inner surface, locking pins 6 which are radially directed towards the center of the ring 3. A vehicle lamp 7 can be locked in the holder 2 by means of the locking pins 6, said lamp comprising a lamp body 8 fastened to a lamp base 9. The lamp body 8 substantially comprises a bulb-shaped discharge vessel with electrodes arranged therein for generating light by means of gas discharge processes, and an outer bulb which encloses the discharge vessel. An electronic circuit serving as a starter (also called igniter) and supplying the lamp 7 during subsequent operation is integrated in the lamp base 9.

Conventional headlights, in particular those of motor vehicles, are serviced from the rear of the reflector housing during an exchange of the lamp. This is in contrast to the arrangement shown in FIG. 1: the arrow E shows an insertion direction of the lamp 7 into the reflector housing 1. It is opposed to the radiation direction of the headlight indicated by the arrow A. The lamp 7 accordingly occupies a position in the assembled state in which its lamp base 9 is positioned in front of the lamp body 8, when viewed against the radiation direction A. The lamp base 9 prevents oncoming traffic from being dazzled by a direct view of the light source in this situation. The provision of a separate radiation screen in this location is made redundant thereby.

The bridges 4 have a first function of supporting the ring 3 and forming the holder 2 in combination therewith. Secondly, they have the function of conducting current via the contact surfaces 5 from and to the electronic circuit in the lamp base 9, i.e. serving as supply lines to the lamp 7. For this purpose, the bridges 4 are connected to the portion of the car network in charge of supplying the headlight with power and are manufactured from a conductive material, for example metal, and are conductively connected to the contact surfaces 5. The bridges 4 and the contact surfaces 5 are insulated from the ring 3. The ring 3 is made, for example, from an insulating material for this purpose. The bridges 4 are in addition insulated by means of a protective lacquer or the like also over their entire length, so that a person exchanging a lamp cannot come into contact with live parts. In particular, the bridges 4 are also insulated from the reflector 1, which will usually be at ground potential. Once the lamp 7 has been inserted into the holder 2 in the direction of arrow E, the lamp body 8 will lie between the bridges 4. The lamp 7 emits electromagnetic interference radiation during operation because it operates by means of gas discharge technology. The arrangement of the three current-conducting bridges 4, which surround the lamp body 8 around its longitudinal axis in symmetrical distribution, however, is capable of screening off this radiation. The holder 2 thus provides an electromagnetic screening of the lamp body 8 at the same time when the lamp 7 is put into operation.

FIG. 2a is a side elevation of a front portion of the holder 2 and the lamp 7. The ring 3 and portions of the bridges 4, of which only two are visible, as well as the contact surfaces 5 and the locking pins 6 covered by the ring 3 are shown of this holder 2. FIG. 2b is an elevation of the lamp 7 viewed against the radiation direction A.

FIGS. 2a and 2b clarify how the holder 2 and the lamp 7 cooperate. When the lamp 7 is applied against the holder 2 in the direction of the arrow E, the ring 3 and a front face 10 of the lamp base 9 facing the reflector housing 1 come into mutual contact. A fit chosen as accurate as possible between the inner diameter of the ring 3 and the outer diameter of a shoulder of the lamp base 9 automatically provides a centering of the lamp 7 in the holder 2. The lamp 7 thus has occupied a position necessary for a perfect co-operation with the reflector housing 1. This position is defined by the reference surface 15 formed by the ring 3 by means of its side facing away from the reflector housing 1.

The lamp 7 is locked to the holder 2 in order to be retained permanently in this position. For this purpose, hooked locking recesses 11 are provided in the shoulder of the front face 10, occupying positions in the lamp base 9 corresponding to those of the locking pins 8 of the ring. When the front face 10 of the ring 3 is brought into abutment, the locking pins 8 are inserted into the locking recesses 11. A rotation of the lamp base 9 about the longitudinal axis a of the lamp 7 causes the locking pins 6 to enter the locking recesses 11 in the manner of a bayonet closure. The lamp 7 is thus fastened in the holder 2 in a captive manner.

The contact surfaces 5 arranged on the ring 3 are associated with counter contacts 12 of the lamp base 9 of corresponding positions and size. The latter are connected to the electronic circuit in the lamp base 9. Simultaneously with the locking of the lamp 7 in the holder 2, accordingly, the electronic circuit in the lamp base 9 is contacted with the bridges 4 which act as electrical supply lines.

Since the locking means 6, 11 and the contacting means 5, 12 are arranged on the same front face 10, and locking and contacting take place in one and the same process step, it suggests itself to perform the locking and contacting by means of the same device. An example of this is shown in FIG. 3. Instead of mutually separated contact surfaces and locking pins, contact locking pins 13 are present on the ring 3 and counter contact locking recesses 14 are arranged in the front face 10, counter contact surfaces 12 being present in depressions thereof. The contact locking pins 13 thus provide the electrical contact with the electronic circuit at the same time during the mechanical locking process.

The contact surfaces 5, 12 and the locking pins 6, or the contact locking pins 13 and the locking recesses 11, 14 are shown in a symmetrical arrangement around the center of the ring 3 for the sake of simplicity. It is possible to define a given orientation of the lamp 7 around its longitudinal axis a by means of a different, i.e. asymmetrical arrangement of the locking pins 6 or the contact locking pins 13 along the ring 3 and of the associated locking recesses 11 or 14 in the lamp base 9. A coding mechanism can be created in this manner which prevents an incorrect arrangement of the contact 5 of the holder 2 with respect to the counter contacts 12 of the lamp base 9 during insertion of the lamp 7, or the insertion of a special lamp type in a headlight not suitable for this.

FIG. 4 shows a headlight 20 which comprises a reflector housing 21 and a front glass 22. Three reflectors 23 and holders 24 for different lamps are arranged in the reflector housing 21. The front glass 22 is pivotably connected to a front edge 26 of the reflector housing 21 by means of two hinges 25, in contrast to the prior art. In addition, closures 27 are arranged at the edge 26, so that a secure closing of the front glass 22 against the reflector housing 21 is safeguarded during operation of the lamp and/or of the vehicle. This construction offers a possibility of exchanging a defective lamp from the front, without the necessity of a removal, let alone a dismantling of other vehicle components.

The reference surface in the arrangement shown is accordingly moved away from the reflector housing 21 in the direction of radiation of the headlight, in contrast to conventional constructions. The lamp base of an inserted lamp, which advantageously abuts against the reference surface, accordingly utilizes the headlight inner space between the reflector housing 21 and the front glass 22 which has been hinged into the operational position. This means that no space has to be reserved anymore on the rear of the reflector housing 21 facing towards the engine compartment of a motor vehicle for supporting the lamp base.

The arrangement according to the invention of a lamp in a headlight is not limited to an insertion of the lamp from the front of a headlight. FIGS. 5a and 5b show a lamp 30 which is inserted from the rear of a reflector housing (not shown) while the advantages described above are still enjoyed, in particular the screening of the lamp body 31 by the bridges 32 of a holder 33 against electromagnetic interference radiation. This holder 33 again comprises a ring 34 which forms a reference surface 35. In contrast to the embodiments described above, the reference surface 35 now lies at the side of the ring 34 facing the reflector housing. A contact surface 38 co-operating with the reference surface 35 is arranged on an end face 36 of the lamp base 37 facing away from the lamp 30. In contrast to the embodiments of the lamp 7 described above, the dimensions of the lamp base 37 are such that it can be passed through the holder 33. Its diameter, however, must not have a smaller dimension than the ring 34 everywhere. If more space is required in the lamp base 37, a possibility is to prolong the lamp base 37 in the radiation direction A of the headlight. According to an alternative possibility, i.e. the one shown, a portion 39 of the lamp base 37 is arranged between the ring 34 and the reflector housing, which portion comprises notches 40 which provide room for movement for the bridges 32 during locking of the lamp 30. In this modification, therefore, lamps are exchanged from the rear of the headlight, as usual, i.e. for example from the engine compartment of a motor vehicle via a suitable opening in the reflector (not shown). This opening may then be closed by means of a simple flat cover or the like. Additional space at the rear of the headlight housing for the lamp base and/or electronic circuit of the lamp is advantageously not required.

FIG. 6 shows an alternative embodiment of a lamp for front insertion into a headlight. A lamp 50 comprises a lamp body 51 which is retained in a lamp body holder 52 and in which an electronic circuit for operating the lamp 50 is accommodated. Three bridges 53 extend from the lamp body holder 52 parallel to the lamp body 51. They serve as supply lines to the electronic circuit and issue into a lamp socket 54, which is arranged at the end of the lamp body 51 opposite to the lamp body holder 52. The lamp socket 54 is substantially disc-shaped and has locking tags 55 arranged in a ring on its side facing away from the lamp body 51. The locking tags 55 form a bayonet closure with an opening 56 shown in broken lines in a reflector housing 57 during mounting of the lamp 50 and define a position of the lamp 50 against a reference surface 58 in the headlight. Since the lamp socket 54 has only one function, i.e. retaining the lamp 50 against the reference surface 58 in the reflector housing, it can be of a very flat construction. In particular, it is not necessary that it should project from the reflector housing 57 into an engine compartment.

It is finally noted once more that the lamps shown in the Figures and described in the text are merely examples of embodiments which may be varied over a wide field by those skilled in the art without departing from the scope of the invention. It is noted for completeness' sake that the use of the indefinite article “a” or “an” does not exclude the presence of a plurality of the relevant items, and that the use of the verb “comprise” does not exclude the existence of further elements.

1. A vehicle headlight with a reflector housing (1, 21) and a front glass (22) which together enclose a headlight inner space, and with a reference surface (15, 35) for defining the position of a lamp (7, 30) having a lamp body (8, 31) and a lamp base (9, 37) inside the headlight, wherein the headlight is constructed such that the lamp (7, 30) can be inserted such that the lamp base (9, 37) is positioned in front of the lamp body (8, 31), when viewed against the radiation direction of the headlight.

2. A vehicle headlight as claimed in claim 1 for a lamp (7, 30) with an electronic circuit integrated in the lamp base (9, 37), characterized in that electrical supply lines (4) for supplying the electronic circuit are provided and are passed alongside the lamp body (8, 31) of an inserted lamp (7, 30) such that said lines screen the lamp (7, 30) against electromagnetic interference radiation issuing therefrom.

3. A vehicle headlight as claimed in claim 2, characterized in that at least three supply lines (4) extend parallel to a longitudinal axis (a) of the lamp body (8, 31) and are arranged in a stellar arrangement around the longitudinal axis (a) of the lamp body (8, 31) at substantially equal angular distances to one another.

4. A vehicle headlight as claimed in claim 2, characterized in that the supply lines (4) are fixedly connected to the reflector housing (1, 21) and form a holder (2) for the lamp (7, 30) in the reflector housing (1, 21) with a reference surface (15, 35).

5. A vehicle headlight as claimed in claim 4, characterized in that the supply lines (4) are electrically connected at their front ends, as seen in the radiation direction, to contacts (5) for contacting the lamp's electronic circuit, and in that the supply lines (4) are mechanically interconnected at said ends by means of a ring (3), which ring (3) represents the reference surface (15, 35) for the lamp (7, 30) in the headlight inner space.

6. A vehicle headlight as claimed in claim 2, comprising contacts (5) of the supply lines (4), characterized in that a mechanical locking of the lamp (7, 30) is provided in the reflector housing (1, 21), and in that contacts (5, 12) between the supply lines (4) and the electronic circuit are closed simultaneously with the locking action.

7. A vehicle headlight with a reference surface (58) in a reflector housing (57) for defining the position of a lamp (50) with a lamp body (51) in the headlight, wherein the lamp (50) comprises a lamp body holder (52) and a lamp socket (54), and the lamp (50) and the headlight are designed such that the lamp (50) can be inserted such that the lamp body holder (52) is arranged in front of the lamp body (51), when viewed against the radiation direction of the headlight, and the lamp socket (54) is arranged behind the lamp body (51) against the reference surface (58).

8. A vehicle headlight, in particular as claimed in claim 1, characterized in that it is designed such that a lamp (7, 30) with an electronic circuit can be inserted from the front into the reflector housing (21) after removal of the front glass (22).

9. A vehicle lamp (7, 30, 50) comprising a lamp body (8, 31, 51), a lamp base (9, 37), a radiation screen, and an electronic circuit for operating the lamp (7, 30, 50), wherein the electronic circuit is arranged in the region of the radiation screen.

10. A vehicle lamp as claimed in claim 8, characterized in that electrical supply lines for supplying the electronic circuit are arranged at or in the lamp body such that they screen off the lamp body (8, 31, 51) against electromagnetic interference radiation issuing therefrom.

11. A vehicle lamp as claimed in claim 8, characterized in that the lamp base (9, 37) is arranged in the region of the radiation screen or serves as a radiation screen.

12. A vehicle lamp as claimed in claim 8, characterized in that the lamp base comprises a lamp body holder (52) and a lamp socket (54), and in that only the lamp body holder (52) is arranged in the region of the radiation screen.

13. (canceled)

14. The use of an electronic component and/or a lamp base (9, 37) of a vehicle lamp (7, 30), which is designed for use in a vehicle headlight, as a radiation screen arranged in front of a lamp body (8, 31) of the lamp (7, 30), as viewed against the radiation direction of the headlight.

15. A method of exchanging a motor vehicle lamp (7, 30) arranged in a lampholder (2, 24) inside a headlight housing (21, 22), which headlight housing (21, 22) comprises a front glass (22) arranged at the front, which front glass (22) encloses a space in conjunction with a reflector housing (21) arranged behind said glass, in which method the front glass (22) is removed, a lamp with its electronic circuit arranged in the space is removed from its lampholder (24), a new, similar lamp is inserted into the lampholder (24), and the space is closed again by means of the front glass (22).
